(19) United States
(12) Patent Application Publication
(10) Pub. No.: US 2009/0041523 A1
(43) Pub. Date: Feb. 12, 2009

(54) Image Forming Apparatus

(75) Inventor: Kunihiko Kanou, Tokoname-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/184,382

(22) Filed: Aug. 1, 2008

(30) Foreign Application Priority Data
Aug. 10, 2007 (JP) 2007-210125
Apr. 17, 2008 (JP) 2008-107760

(51) Int. Cl. G03G 15/00

(52) U.S. Cl. 399/406

(57) ABSTRACT

An image forming apparatus which inhibits sheet curl without requesting a user to do tiresome work, such as resetting of sheets. On a touch panel, a user makes a setting whether to inhibit sheets of a printing medium from curling. When the setting indicates necessity of inhibiting sheet curl, a controller controls a reversing section and feed rollers to turn over and feed a sheet, and when the setting indicates unnecessity of inhibiting sheet curl, the controller controls the reversing section and the feed rollers to feed a sheet without turning over the sheet.

This application is based on Japanese Application No. 2007-210125 filed on Aug. 10, 2007 and Japanese Application No. 2008-107760 filed on Apr. 17, 2008, of which contents are incorporated herewith by reference.

### BACKGROUND OF THE INVENTION

1. Field of the Invention

The present invention relates to an image forming apparatus, and more particularly to an image forming apparatus for forming toner images by an electrophotographic method.

2. Description of Related Art

Recently, the percentage of recycled paper to all paper used is getting higher, and image forming apparatuses are demanded to have high printing performance to recycled paper. However, recycled paper is apt to curl when it is ejected from an image forming apparatus. Then, sheets of recycled paper may be out of alignment in a finisher, and trouble may occur when sheets of recycled paper are ejected onto a tray.

It is known that a measure to deal with the trouble of curl of recycled paper is resetting sheets of recycled paper in a sheet cassette with the sheets turned over. Therefore, user's manuals of conventional image forming apparatuses say that as a measure to deal with curl of recycled paper, sheets should be taken out of a sheet cassette, turned over and reset in the sheet cassette.

According to the user's manuals, however, when curl of recycled paper occurs, the user himself/herself needs to turn over sheets of recycled paper in a sheet cassette and reset the sheets, which is tiresome work for the user.

As means for suppressing curl of paper, JP5-155516A suggests a stacker for a printer, and JP8-175732A suggests a sheet curl correction device. The stacker disclosed by JP5-155516A presses down a curling sheet with paddles so as to suppress the sheet curl. The sheet curl correction device disclosed by JP8-175732A detects the curling direction of a sheet and pinches the curling sheet between belts so as to correct the sheet curl.

### SUMMARY OF THE INVENTION

An object of the present invention is to provide an image forming apparatus which can inhibit sheet curl without requiring a user to do tiresome work, such as reset of sheets.

An image forming apparatus according to an aspect of the present invention comprises: a cassette for containing sheets of a printing medium; a reverser for turning over a sheet of the printing medium; a feeder for feeding a sheet of the printing medium; a printer for printing an image on the sheet fed by the feeder; a curl inhibition information receiver for receiving curl inhibition information on whether to inhibit the sheet from curling; and a controller for controlling the reverser and the feeder, when the curl inhibition information received by the curl inhibition information receiver indicates necessity of inhibiting sheet curl, the controller controlling the reverser and the feeder to turn over and feed a sheet, and when the curl inhibition information received by the curl inhibition information receiver indicates unnecessity of inhibiting sheet curl, the controller controlling the reverser and the feeder to feed a sheet without turning over the sheet.

### BRIEF DESCRIPTION OF THE DRAWINGS

This and other objects and features of the present invention will be apparent from the following description with reference to the accompanying drawings, in which:

FIG. 1 is a schematic view of an image forming apparatus according to a first embodiment, showing the structure of the apparatus;

FIG. 2 is a flowchart showing a mode setting procedure carried out by a control section of the image forming apparatus according to the first embodiment;

FIG. 3 is an illustration of an exemplary mode setting screen;

FIG. 4 is a flowchart showing a printing procedure carried out by the control section;

FIG. 5 is a flowchart showing a mode canceling procedure carried out by the control section;

FIG. 6 is a schematic view of an image forming apparatus according to a second embodiment, showing the structure of the apparatus;

FIGS. 7a and 7b are illustrations of a sheet-curl detecting section, showing the structure of the section;

FIG. 8 is a flowchart showing a procedure carried out by a control section of the image forming apparatus according to the second embodiment;

FIG. 9 is an illustration showing a sheet traveling direction in an image forming apparatus;

FIG. 10 is an illustration showing a sheet traveling direction in an image forming apparatus;

FIG. 11 is an illustration showing a sheet traveling direction in an image forming apparatus;

FIG. 12 is a flowchart showing a mode setting procedure carried out by a control section of an image forming apparatus according to a third embodiment;

FIG. 13 is an illustration of an exemplary mode setting screen; and

FIG. 14 is a flowchart showing a printing procedure carried out by the control section of the image forming apparatus according to the third embodiment.

### DETAILED DESCRIPTION OF THE PREFERRED EMBODIMENTS

### First Embodiment

### General Structure of Image Forming Apparatus

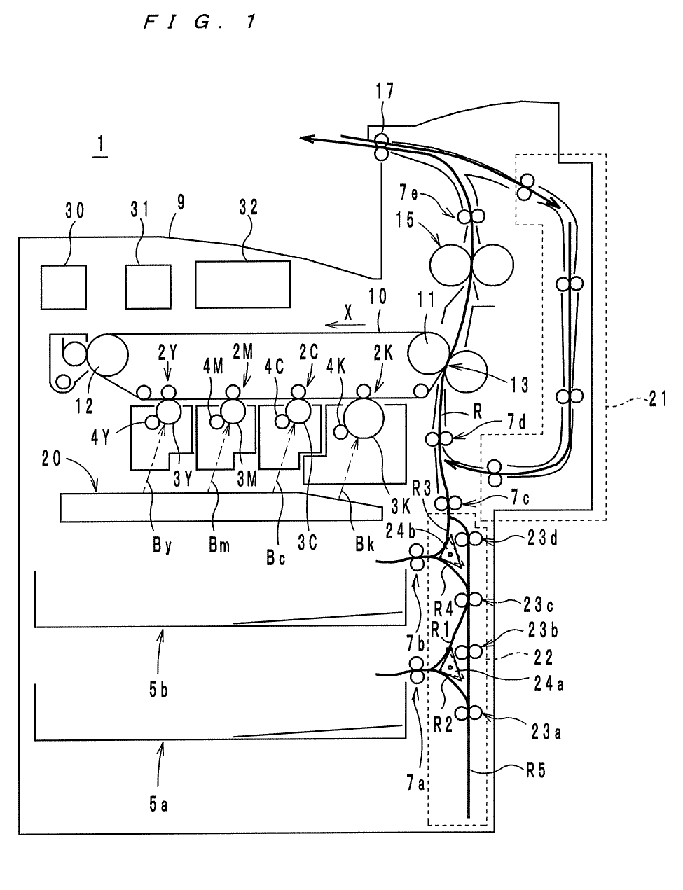

First, an image forming apparatus according to a first embodiment of the present invention is described with reference to the drawings. Referring to FIG. 1, the general structure of an image forming apparatus 1 is described. In the following paragraphs, “Y” and “y” mean yellow, “M” and “m” mean magenta, “C” and “c” mean cyan, and “K” and “k” mean black.

The image forming apparatus 1 is a color printer which combine four color images by a tandem method. The image forming apparatus 1 comprises image forming stations 2Y, 2M, 2C and 2K, automatic sheet-feed cassettes 5a and 5b, pairs of feed rollers 7a, 7b, 7c, 7d and 7e, a sheet ejection section 9, a transfer belt 10, a driving roller 11, a driven roller 12, a fixing device 15, a pair of ejection rollers 17, an optical scanning device 20, a backing section 21, a reversing section 22, a control section 30, a storage section 31 and a touch panel 32.

The image forming stations 2Y, 2M, 2C and 2K are arranged immediately below the transfer belt 10. The image forming stations 2Y, 2M, 2C and 2K comprises photosensitive drums 3Y, 3M, 3C and 3K, developing devices 4Y, 4M, 4C and 4K, chargers (not shown), residual toner cleaners (not shown), etc. The image forming station 2K for forming black images is made large, and in the image forming apparatus 1, forming of monochromatic images, which is often required, is speedy.

The optical scanning device 20 is arranged immediately below the image forming stations 2Y, 2M, 2C and 2K. The optical scanning device 20 emits beams By, Bm, Bc and Bk to the respective photosensitive drums 3 in accordance with image data Y, M, C and K. Thereby, electrostatic latent images are formed on the circumferential surfaces of the photosensitive drums 3. The electrostatic latent images are developed with toner into visible images. This electrophotographic process is well known, and a description thereof is omitted.

The transfer belt 10 is laid between the driving roller 11 and the driven roller 12 and is rotated in a direction “X”. The toner images of the respective colors are sequentially transferred from the photosensitive drums 3 onto the surface of the transfer belt 10 (first transfer) and are combined into a composite image.

The automatic sheet-feed cassettes 5a and 5b are stored with printing medium, such as recycled paper, of mutually different sizes (for example, A4 vertical and B5 vertical), and the printing medium is fed out sheet by sheet at specified timing. Now, the sheet size is described. For example, A4 vertical means lateral feeding of A4-sized sheets. More specifically, A4-sized sheets are set with the longer sides extending from front to rear of the image forming apparatus 1, and the sheets are fed in a direction along the shorter sides of the sheets. On the other hand, A4 lateral means vertical feeding of A4-sized sheets. More specifically, A4-sized sheets are set with the shorter sides extending from front to rear of the image forming apparatus 1, and the sheets are fed in a direction along the longer sides of the sheets. Although only two automatic sheet-feed cassettes 5a and 5b are shown in FIG. 1, actually, more automatic sheet-feed cassettes are provided so that printing medium of various sizes can be stored. The pairs of feed rollers 7a, 7b, 7c, 7d and 7e form a sheet feed route R and serve as a sheet feeder.

A second transfer section 13 and the fixing device 15 are located on the sheet feed route R and serve as a printer. At the second transfer section 13, the composite toner image is transferred from the transfer belt 10 to a sheet of printing medium (second transfer). The fixing device 15 fixes the toner image onto the sheet by heat. The pair of ejection rollers 17 ejects the sheet with the toner image fixed thereon onto the sheet ejection section 9.

In double-side printing, the pair of ejection rollers 17 conveys the sheet outward from the image forming apparatus 1 and thereafter feeds the sheet backward into the image forming apparatus 1. The backing section 21 receives the sheet fed back from the ejection rollers 17 and feeds the sheet back to the second transfer section 13. At the second transfer section 13, a toner image is transferred onto the reverse side of the sheet. Then, the pair of ejection rollers 17 ejects the sheet onto the sheet ejection section 9.

The control section 30 is, for example, a CPU and controls the whole image forming apparatus 1. The storage section 31 is, for example, a hard disk and is stored with image data and other various kinds of data. The touch panel 32 serves as an information receiver for receiving inputs from users and also as a display for giving information to the users by displaying various images.

If the printing medium is recycled paper and if sheets of the recycled paper are set wrong side down on the automatic sheet-feed cassettes 5a and 5b, the printing medium will curl, when it passes by the fixing device 15. The image forming apparatus 1 according to this embodiment, in response to a user's order, after turning over the printing medium set in the automatic sheet-feed cassettes 5a and 5b sheet by sheet, forms images on the sheets. This operation is described below.

When curl of a printing medium occurs, a user can set a curl, inhibition mode in the image forming apparatus 1. The curl inhibition mode is a mode to inhibit curl of a printing medium. Specifically, the image forming apparatus 1 turns over sheets of a printing medium set in the sheet-feed cassettes 5a and 5b before forming images on the sheets. On the other hand, a mode wherein the image forming apparatus 1 forms images on sheets without turning over the sheets is called an ordinary mode. In the ordinary mode, curl of a printing medium is not inhibited.

The storage section 31 is stored with a first table as shown by Table 1, in which settings (information) on the curl inhibition mode and the ordinary mode are recorded for sheet sizes (i.e. for the respective automatic sheet-feed cassettes 5a and 5b). In Table 1, “ON” in the column of Mode means a setting of the curl inhibition mode for the corresponding sheet size, and “OFF” in the column of Mode means a setting of the ordinary mode for the corresponding sheet size.

TABLE 1

| Sheet Size | Mode |
|---|---|
| (1) A4 Vertical | ON |
| (2) A4 Lateral | OFF |
| (3) B5 Vertical | ON |
| (4) B5 Lateral | OFF |

The user inputs settings (information) on the curl inhibition mode and the ordinary mode for sheet sizes of a printing medium (i.e. the automatic sheet-feed cassettes 5a and 5b) by use of the touch panel 32. In this moment, the touch panel 32 serves as an information receiver for receiving information as to whether it is necessary to inhibit curl of the printing medium. In accordance with the information inputted, the control section 30 updates the first table in the storage section 31.

When the control section 30 receives a print job from the user, the control section 30 commands the feed rollers 7a, 7b, 7c, 7d and 7e and the reversing section 22 to feed the printing medium in the curl inhibition mode or in the ordinary mode in accordance with the settings in Table 1. In the curl inhibition mode, the control section 30 commands the automatic sheet-feed cassette 5a or 5b containing the printing medium of a sheet size designated by the print job to feed a sheet therefrom. Next, the control section 30 commands the reversing section 22 to turn over the sheet. Thereafter, the feed rollers 7a, 7b, 7c, 7d and 7e feed the turned-over sheet. In the ordinary mode, on the other hand, the reversing section 22 does not operate, and the feed rollers 7a, 7b, 7c, 7d and 7e feed a sheet of the printing medium. The structure of the reversing section 22 is described below.

The reversing section 22 comprises pairs of reversing rollers 23a, 23b, 24c and 23d, switch pawls 24a and 24b, and routes R1, R2, R3, R4 and R5. A sheet-feeding path from the automatic sheet-feed cassette 5a diverges into the routes R1 and R2. The route R1 is connected to the sheet feed route R. The route R2 is connected to the sheet reversing route R5. A sheet-feeding path from the automatic sheet-feed cassette 5b diverges into the routes R3 and R4. The route R3 is connected to the sheet feed route R, and the route R4 is connected to the reversing route R5.

The switch pawl 24a switches the route of a sheet fed from the automatic sheet-feed cassette 5a between the route R1 connected to the sheet feed route R and the route R2 in accordance with a command from the control section 30. When the sheet is fed to the route R2, the sheet is then fed to the reversing route R5 by the pair of reversing rollers 23a. Thereby, the sheet is turned over. Next, the pair of reversing rollers 23a is rotated in reverse and conveys the sheet upward. Thereafter, the reversing rollers 23b, 24c and 23d feed the turned-over sheet into the sheet feed route R.

The switch pawl 24b switches the route of a sheet fed from the automatic sheet-feed cassette 5b between the route R3 connected to the sheet feed route R and the route R4 in accordance with a command from the control section 30. When the sheet is fed to the route R4, the sheet is then fed to the reversing route R5 by the pairs of reversing rollers 23a, 23b and 23c. Thereby, the sheet is turned over. Next, the pairs of reversing rollers 23a, 23b and 24c are rotated in reverse and convey the sheet upward. Thereafter, the pair of reversing rollers 23d feeds the turned-over sheet into the sheet feed route R.

### Operation of the Image Forming Apparatus

Next, referring to the drawings, the operation of the image forming apparatus 1 of the above-described structure is described. The image forming apparatus 1 performs a mode setting operation, a printing operation and a mode canceling operation. In the mode setting operation, a user sets the curl inhibition mode in the image forming apparatus 1. In the printing operation, the image forming apparatus 1 performs printing on sheets of a printing medium. In the mode canceling operation, the image forming apparatus 1 automatically resets the curl inhibition mode to the ordinary mode under specified conditions.

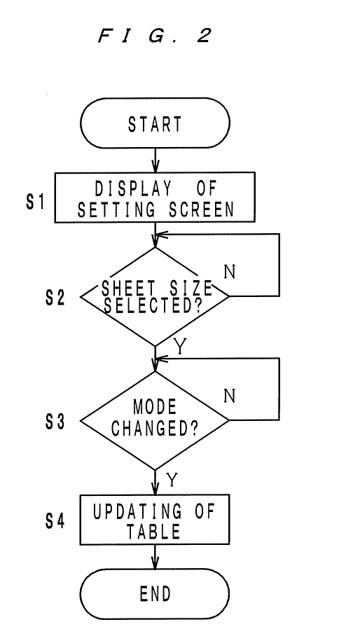

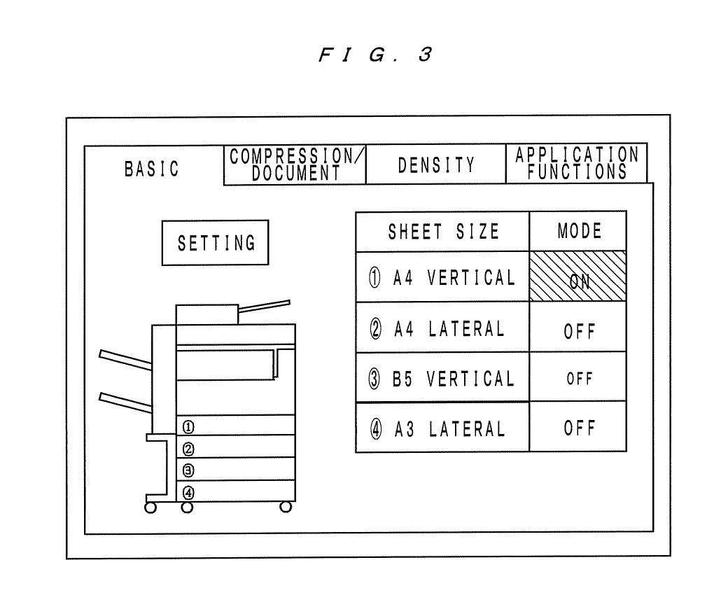

First, referring to FIGS. 2 and 3, the mode setting operation is described.

The user operates the touch panel 32. In response to the operation, the control section 30 displays a setting screen as shown by FIG. 3 on the touch panel 32 (step S1). In the setting screen, “Sheet Size” and “Mode” are displayed relative to each other. The “Mode” means the curl inhibition mode. “ON” means that the curl inhibition mode is set, and “OFF” means that the ordinary mode is set.

The control section 30 stands by while detecting whether the user has selected a sheet size for the mode setting (step S2). In the meantime, the user selects a sheet size for the mode setting at the touch panel 32. In FIG. 3, the sheet size “A4 vertical” is selected.

Next, the control section 30 stands by while detecting whether the user has changed the mode from the ordinary mode (OFF) to the curl inhibition mode (ON) (step S3). In the meantime, the user changes the mode for the selected sheet size from OFF to ON. In FIG. 3, the mode for the sheet size “A4 Vertical” is changed from OFF to ON. Then, the mode setting operation is completed.

Next, the control section 30 updates the first table stored in the storage section 31 (step S4). In the case of FIG. 3, the control section updates the first table so that the mode for the sheet size “A4 Vertical” will be changed from OFF to ON. Then, the mode setting operation is completed.

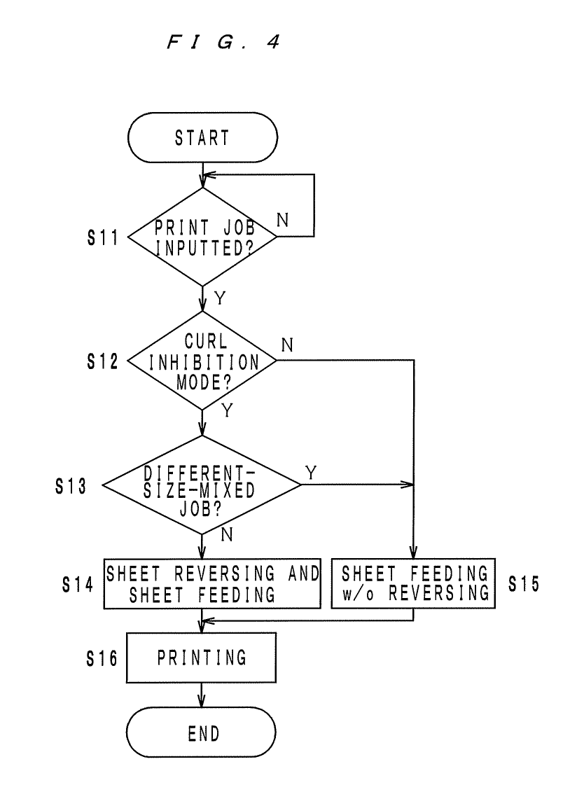

Next, referring to FIG. 4, the printing operation is described.

The control section 30 stands by while detecting whether a print job has been inputted (step S11). By operating the touch panel 32, the user selects a sheet size and makes a print start command. If the print job is a different-size-mixed job which commands the image forming apparatus 1 to print images on sheets of different sizes, the user makes an input at the touch panel 32 to indicate that the print job is a different-size-mixed job. Thus, the control section 30 receives a print job.

When the control section 30 receives a print job, the control section 30 reads the sheet size contained in the print job, and referring to the first table, the control section 30 judges whether the curl inhibition mode is set for the sheet size (step S12). When the curl inhibition mode is set, the processing goes to step S13. When the curl inhibition mode is not set, the processing goes to step S15.

When the curl inhibition mode is set, the control section 30 judges whether the print job is a different-size-mixed job (step S13). When the print job is not a different-size-mixed job, the processing goes to step S14. When the print job is a different-size-mixed job, the processing goes to step S15.

When the print job is not a different-size-mixed job, the control section 30 commands the reversing section 22 and the feed rollers 7a and 7b to turn over and feed sheets (step S14). More specifically, the control section 30 commands the automatic sheet-feed cassette 5a or 5b containing sheets of the size indicated by the print job to feed a sheet out. Next, the control section 30 controls the posture of the switch pawl 24a or 24b so that the sheet can be guided to the route R2 or R4. Then, the control section 30 commands the reversing rollers 23a or 24c to convey the sheet down to the reversing route R5. Thereafter, the control section 30 reverses the rotations of the reversing rollers 23a, 23b and 23c, so that the sheet is conveyed upward from the reversing route R5. Then, the processing goes to step S16.

At step S15, the control section 30 controls the feed rollers 7a or 7b and the reversing section 22 to feed a sheet without turning over the sheet. More specifically, the control section 30 commands the automatic sheet-feed cassette 5a or 5b containing sheets of the size indicated by the print job to feed a sheet out. Next, the control section 30 controls the posture of the switch pawl 24a or 24b so that the sheet fed out of the automatic sheet-feed cassette 5a or 5b can be guided toward the sheet feed route R. Thereby, the sheet is fed to the sheet feed route R. Then, the processing goes to step S16.

At step S16, the control section 30 controls printing on the sheet. More specifically, the control section 30 commands the feed rollers 7c, 7d and 7e to feed the sheet. While the sheet is traveling, a toner image is transferred onto the sheet at the second transfer section 13, and the toner image transferred to the sheet is fixed thereon at the fixing device 15. Thereafter, the sheet with an image printed thereon is ejected onto the ejection section 9 via the pair of ejection rollers 17. The processes at step S14 and step S16 are repeated until the print job is completed. Then, the printing operation is completed.

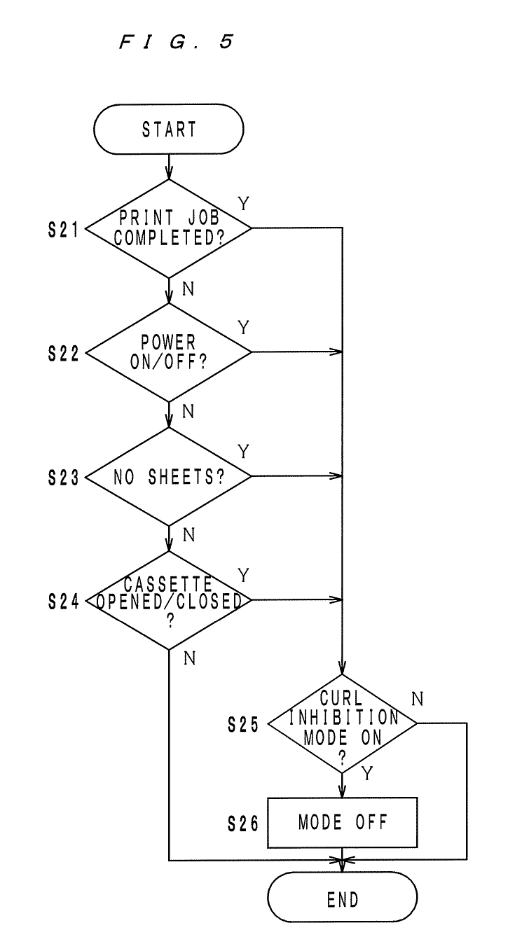

Next, referring to FIG. 5, the mode canceling operation is described. The image forming apparatus 1 according to this embodiment performs the mode canceling operation when a print job is completed, when the power switch is turned on or off, when the automatic sheet-feed cassette 5a or 5b becomes empty, or when the automatic sheet-feed cassette 5a or 5b is opened and closed.

First, the control section 30 judges whether a print job has been completed (step S21). Here, it is judged whether a print job immediately after a user's setting of the curl inhibition mode has been completed. When the print job has not been completed, the processing goes to step S22. When the print job has been completed, the processing goes to step S25.

When the print job has not been completed, the control section 30 judges whether the image forming apparatus 1 has been turned on/off (step S22). Here, it is judged whether the image forming apparatus 1 has been turned on/off since the user's previous setting of the curl inhibition mode until the judgment at step S22. When the image forming apparatus 1 has not been turned on or off, the processing goes to step S23. When the image forming apparatus 1 has been turned on or off, the processing goes to step S25.

When the image forming apparatus 1 has not been turned on or off, the control section 30 judges whether the automatic sheet-feed cassette 5a or 5b is emptied of a printing medium (step S23). When the automatic sheet-feed cassette 5a or 5b is empty, the processing goes to step S25. When the automatic sheet-feed cassette 5a or 5b is not empty, the processing goes to step S24.

When the automatic sheet-feed cassette 5a or 5b is not empty, the control section 30 judges whether the automatic sheet-feed cassette 5a or 5b has been opened/closed (step S24). Here, it is judged whether the automatic sheet-feed cassette 5a or 5b has been opened/closed since the user's previous setting of the curl inhibition mode until the judgment at step S24. When the automatic sheet-feed cassette 5a or 5b has been opened/closed, the processing goes to step S25. When the automatic sheet-feed cassette 5a or 5b has not been opened/closed, the control section 30 judges that it is not necessary to update the first table. Then, the mode canceling operation is completed.

At step S25, referring to the first table as shown by Table 1, the control section 30 judges whether the mode for any sheet size is “ON” (step S25). When “ON” is recorded in the column of “Mode” for any sheet size, the processing goes to step S26. When “ON” is not recorded in the first table, the control section 30 judges that it is not necessary to update the first table. Then, the mode canceling operation is completed.

When “ON” is recorded in the first table, the control section 30 changes the mode for the sheet size indicated by the print job of which completion has been detected at step S21, the mode for the size of sheets which were contained in the automatic sheet-feed cassette of which emptiness has been detected at step S23 or the mode for the size of sheets which were contained in the automatic sheet-feed cassette of which open/close motion has been detected at step S24 from “ON” to “OFF” (step S26). That is, the control section 30 changes the mode for the sheet size from the curl inhibition mode to the ordinary mode. When the control section 30 judges that the image forming apparatus 1 has been turned on/off at step S22, the modes for all the sheet sizes are changed from “ON” to “OFF”. Then, the mode canceling operation is completed.

### Advantages

In the image forming apparatus 1 according to the first embodiment, as described above, in accordance with a user's input, a sheet of a printing medium is turned over, and an image is formed on the turned-over sheet. Therefore, the image forming apparatus 1 inhibits sheets of a printing medium from curling effectively without requiring the user to do tiresome work.

### Modification

In the image forming apparatus 1 according to the embodiment above, the control section 30 changes the curl inhibition mode to the ordinary mode when a print job is completed, when the image forming apparatus 1 is turned on or off, when the automatic sheet-feed cassette 5a or 5b becomes empty or when the automatic sheet-feed cassette 5a or 5b is opened and closed. However, the times when the mode is changed from the curl inhibition mode to the ordinary mode are not limited to these cases. The control section 30 may be designed to change the mode from the curl inhibition mode to the ordinary mode at any times when the user can reset sheets in the automatic sheet-feed cassettes 5a and 5b. Also, the image forming apparatus 1 may be designed such that users can input the times to change the mode arbitrarily by using the touch panel 32 as an input part. In this case, the storage section 31 is stored with a second table as shown by Table 2 below.

TABLE 2

| Timing of Mode Canceling Operation | Automatic Cancel |
|---|---|
| Completion of Print Job | ON |
| Emptiness of Sheet Cassette | OFF |
| Open/Close Motion of Sheet Cassette | ON |
| Power On/Off | OFF |

In the second table, the times when the control section 30 automatically changes the mode from the curl inhibition mode to the ordinary mode are recorded. “ON” in the column of “Automatic Cancel” indicates that the control section 30 automatically changes the mode from the curl inhibition mode to the ordinary mode at the corresponding time.

### Second Embodiment

Next, an image forming apparatus 1 according to the second embodiment is described.

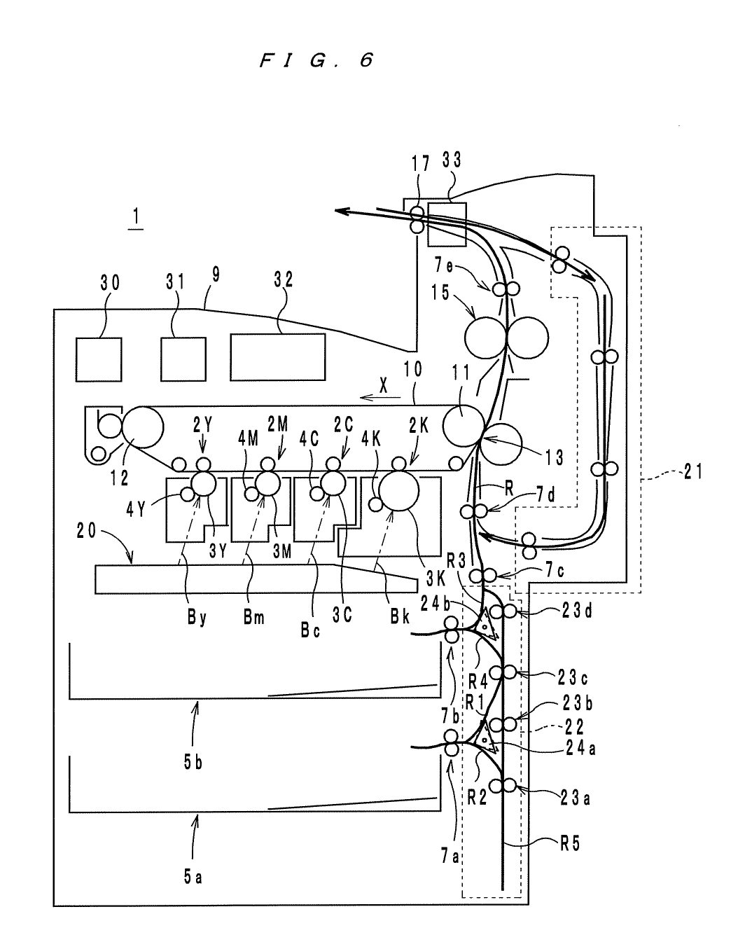

As shown by FIG. 6, only the difference between the image forming apparatus 1 according to the first embodiment and the image forming apparatus 1 according to the second embodiment is whether the apparatus has a detecting section 33. In the following, the detecting section 33 is described with reference to the drawings.

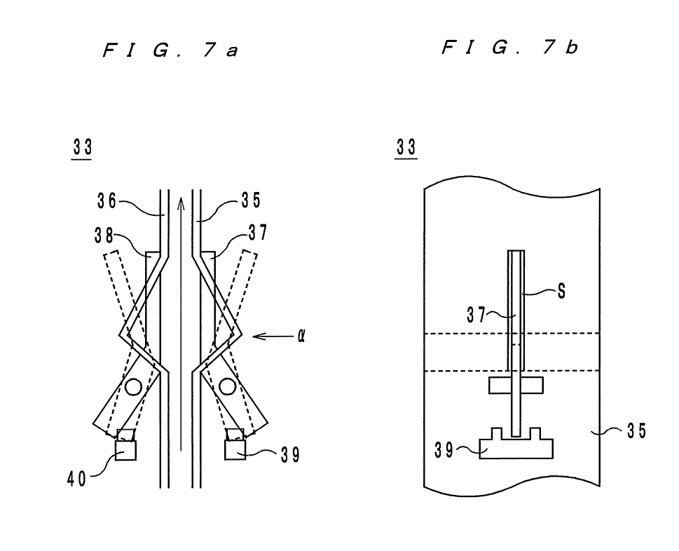

As shown by FIGS. 7a and 7b, the detecting section 33 comprises guides 35 and 36, detector plates 37 and 38 and sensors 39 and 40. The guides 35 and 36, which are metal plates or the like, are substantially parallel to each other and regulate the traveling direction of sheets of a printing medium. As shown by FIG. 7a, the guides 35 and 36 have a protruding portion, which is formed, for example, by bending the metal plates. Further, the guides 35 and 36 have slits S although FIG. 7b shows only a slit S made in the guide 35.

The detector plates 37 and 38 are fitted outside the guides 35 and 36 in such a way to pivot in a plane perpendicular to the guides 35 and 36. The detector plates 37 and 38 come inside the protruding portion of the guides 35 and 36 through the slits S. The sensors 39 and 40 are arranged around ends of the respective detector plates 37 and 38 and detect the states of the detector plates 37 and 38. More specifically, while the detector plates 37 and 38 are partly inside the protruding portion of the guides 35 and 36 as shown by the solid lines in FIG. 7a, it does not occur that the detector plates 37 and 38 shield light receiving portions of the sensors 38 and 40. In this state, high-level signals are outputted from the sensors 39 and 40. On the other hand, when the detector plates 37 and 38 turn outward from the protruding portion of the guides 35 and 36 as shown by the dashed lines in FIG. 7a, the detector plates 37 and 38 shield the light receiving portions of the sensors 39 and 40. In this state, low-level signals are outputted from the sensors 39 and 40.

With the structure above, when a curled sheet passes the detecting section 33, the sheet pushes the detector plate 37 or 38, and as shown by the dashed lines in FIG. 7a, the pushed detector plate 37 or 38 shields the light receiving portion of the sensor 39 or 40. On the other hand, when a non-curled sheet passes the detecting section 33, the sheet does not touch either of the detector plates 37 and 38, and as shown by the solid lines in FIG. 7a, neither of the detector plates 37 and 38 shields the light receiving portions of the sensors 39 and 40. Based on the signals outputted from the sensors 39 and 40, the control section 30 judges whether sheet curl occurs.

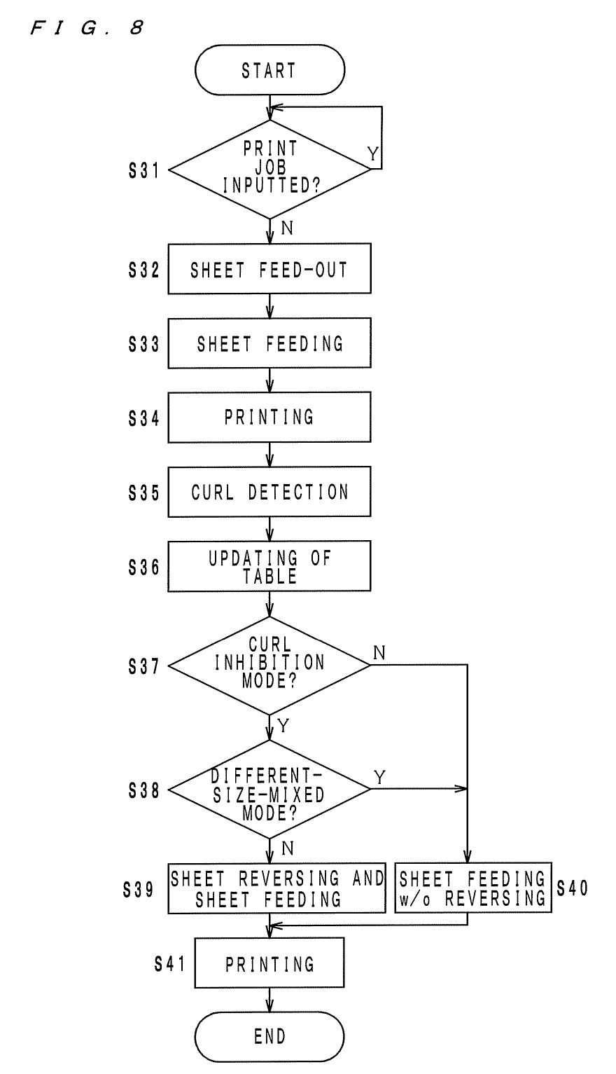

In the image forming apparatus with the detecting section 33, in response to a print job, first, printing is performed on one sheet so that the detecting section 33 can detect whether sheet curl occurs. Thus, the detecting section 33 serves as an information receiver for receiving information on whether to inhibit sheet curl. When occurrence of sheet curl is detected, the image forming apparatus 1 performs printing in the curl inhibition mode. Next, referring to FIG. 8, operation of the image forming apparatus 1 is described.

First, the control section 30 stands by while detecting whether a print job has been inputted (step S31). A user selects a sheet size of a printing medium and makes a print start command by operating the touch panel 32. If the print job is a different-size-mixed job wherein the image forming apparatus 1 performs printing on sheets of different sizes, the user inputs at the touch panel 32 that it is a different-size-mixed job. In this way, the control section 30 receives a print job.

The control section 30 which has received a print job commands the automatic sheet-feed cassette 5a or 5b containing sheets of the size designated by the print job to feed out only one sheet (step S32).

After a sheet is fed out of the cassette 5a or 5b, the control section 30 rotates the pairs of feed rollers 7a, 7b, 7c, 7d and 7e to feed the sheet. A toner image is transferred onto the sheet at the second transfer section 13, and the transferred image is fixed on the sheet by the fixing device 15. In this way, an image is printed on the sheet (step S34). If the sheet is recycled paper, depending on the setting direction of the recycled paper sheets in the cassette 5a and 5b, sheet curl occurs.

Next, the sheet passes through the detecting section 33. In this moment, based on a low-level signal or a high-level signal outputted from the detecting section 33, the control section 30 judges whether sheet curl occurs (step S35). When a low-level signal is outputted, the control section 30 judges that sheet curl is occurring. On the other hand, when a high-level signal is outputted, the control section 30 judges that sheet curl is not occurring. Then, the control section 30 updates the first table stored in the storage section 31 (step S36).

Next, the control section 30 recognizes the sheet size designated by the print job, and referring to the first table as shown by Table 1, the control section 30 judges whether the curl inhibition mode is set for the sheet size (step S37). If the curl inhibition mode is set, the processing goes to step S38. If the curl inhibition mode is not set, the processing goes to step S40.

When the inhibition mode is set, the control section 30 judges whether the print job is a different-size-mixed mode (step S38). When it is not a different-size-mixed mode, the processing goes to step S39. When it is a different-size-mixed mode, the processing goes to step S40.

When it is not a different-size-mixed mode, the control section commands the reversing section 22 and the pairs of feed rollers 7a and 7b to feed and turn over a sheet (step S40). More specifically, the control section 30 commands the automatic sheet-feed cassette 5a or 5b which contains sheets of the size designated by the print job to feed out a sheet. Next, the control section 30 controls the direction of the switch pawl 24a or 24b to guide the fed-out sheet into the route R2 or R4. Then, the control section 30 commands the pairs of reverse rollers 23a and/or 24c to feed the sheet downward into the reversing route R5. Thereafter, the control section 30 reverse the rotation of the reverse rollers 23a and 24c to convey the sheet upward from the reversing route R5. Thereby, the sheet is fed into the sheet feed route R with the sheet turned over. Thereafter, the processing goes to step S41.

At step S40, the control section 30 commands the feed rollers 7a and 7b to feed a sheet without turning over the sheet (step S40). More specifically, the control section 30 commands the automatic sheet-feed cassette 5a or 5b which contains sheets of the size designated by the print job to feed out a sheet. Next, the control section 30 controls the direction of the switch pawl 24a or 24b to guide the fed-out sheet to the sheet feed route R. Thereby, the sheet is fed into the sheet feed route R. Thereafter, the processing goes to step S41.

At step S41, the control section 30 controls printing on the sheet (step S41). More specifically, the control section 30 commands the feed rollers 7c, 7d and 7e to feed the sheet. In the meantime, a toner image is transferred onto the sheet at the second transfer section 13, and the transferred toner image is fixed on the sheet by the fixing device 15. Thereafter, the sheet with an image printed thereon is ejected onto the ejection section 9 through the pair of ejection rollers 17. The processes at steps S39 to S41 are repeated until the print job is completed.

### Advantages

As described above, in the image forming apparatus 1 according to the second embodiment, the detecting section 33 detects whether a first printed sheet curls, and when sheet curl occurs, printing on the succeeding sheets are performed after turning over the sheets. Consequently, the image forming apparatus 1 inhibits printed sheets from curling effectively while saving the user from tiresome work.

Further, as in the image forming apparatus 1 according to the first embodiment, the mode canceling operation may be performed in the image forming apparatus 1 according to the second embodiment.

### Third Embodiment

Next, an image forming apparatus according to a third embodiment is described.

In the first embodiment and in the second embodiment, sheets of a printing medium do not have directivity. Therefore, even when a sheet of a printing medium is turned over and fed in the curl inhibition mode, it is not necessary to consider matching between the sheet traveling direction and the printing direction.

However, for example, when punched sheets are set in the automatic sheet-feed cassettes 5a and 5b, there are cases that the sheet traveling direction may not match with the printing direction. These cases are described in details below.

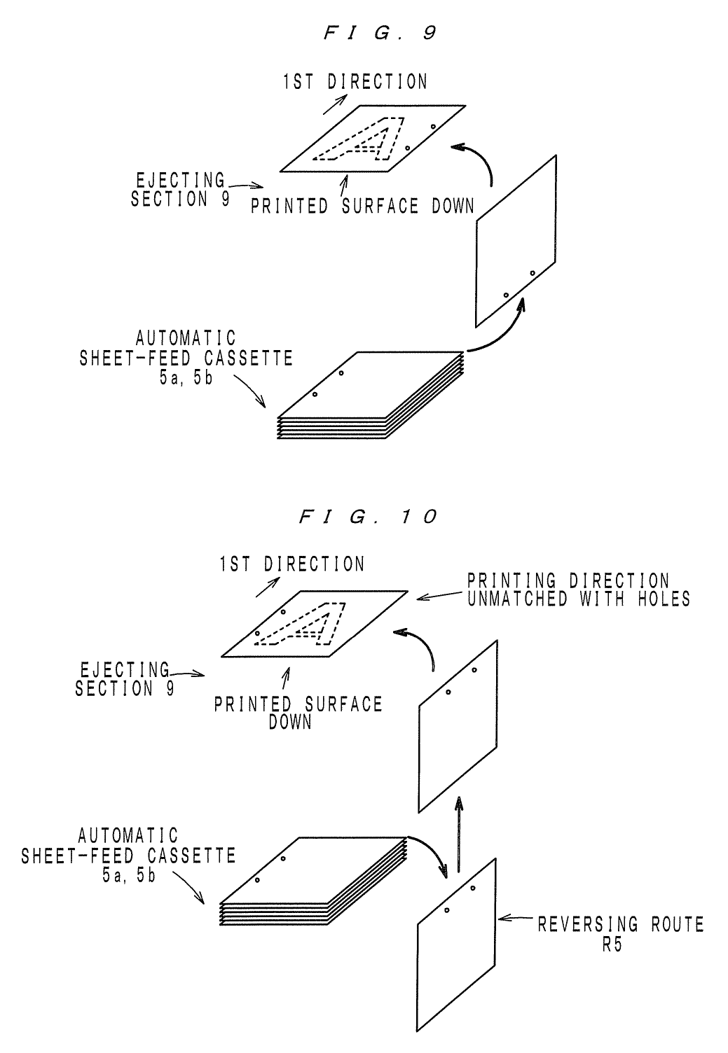

Here, punched sheets are supposed to be set in the automatic sheet-feed cassettes 5a and 5b such that the holes made in the sheets will be at the trailing end of each sheet when it is fed out of the cassettes 5a or 5b. In the ordinary mode, an image is printed on the upper surface of the sheet, which is the surface which faced up when the sheet was set in the automatic sheet-feed cassettes 5a or 5b (see FIG. 9). Accordingly, the sheet is ejected onto the ejection section 9 with the printed surface down, with the holes in the right side and with the upper side of the printed image in the rear side. This state is hereinafter referred to as a matched state in which the printing direction and the position of the holes are matched with each other. Printing an image such that the upper side of the image will be located in the rear side is referred to as printing an image in a first direction.

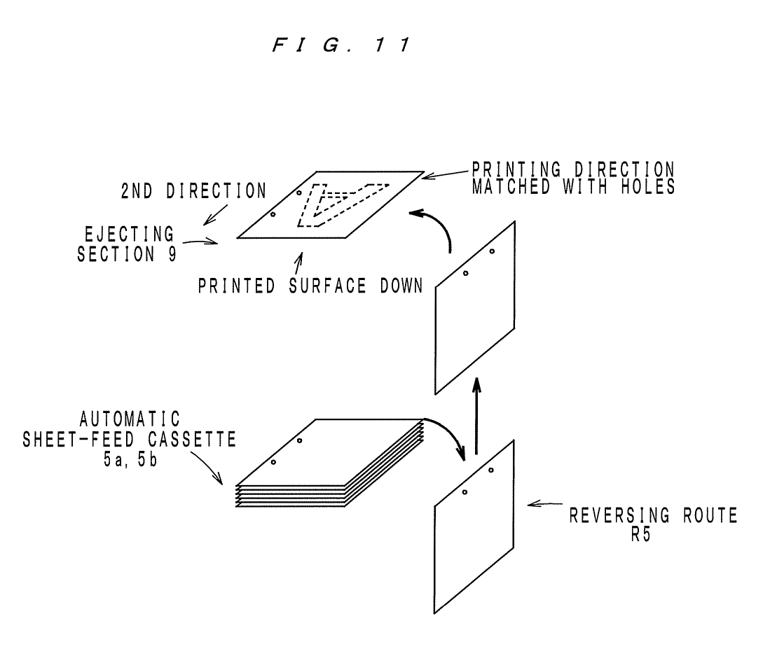

In the curl inhibition mode, on the other hand, the sheet is turned over in the reversing route R5 and then fed to obtain an image thereon (see FIG. 10). Accordingly, the sheet is fed from the reversing route R5 with the holes at the leading end of the sheet, and an image is printed on the lower surface of the sheet, which faced down when it was set in the automatic sheet-feed cassette 5a or 5b. Then, the sheet is ejected onto the ejection section 9 with the printed surface down, with the holes in the left side and with the upper side of the printed image in the rear side. Thus, in the curl inhibition mode, the printing direction and the position of the holes are not matched with each other. This state is referred to as an unmatched state.

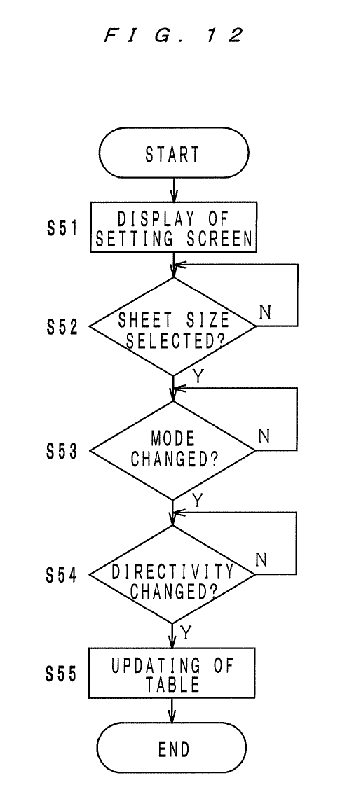

In order to avoid the unmatched state, when the curl inhibition mode is selected, the image forming apparatus 1 according to the third embodiment prints an image on a sheet such that the image will be rotated at 180 degrees to the first direction (see FIG. 11). Thereby, the sheet is ejected onto the ejection section 9 with the printed surface down and with the upper side of the printed image in the front side. That is, the printing direction and the position of the holes are matched with each other. The direction of the printed image rotated at 180 degrees to the first direction is referred to as a second direction.

Next, the above-described operation of the image forming apparatus 1 according to the third embodiment is described in more detail. The image forming apparatus 1 according to the third embodiment is of the same structure as the image forming apparatus 1 according to the first embodiment. In the following, the differences between the first embodiment and the third embodiment will be described.

According to the third embodiment, a user can make settings of mode and directivity for each sheet size in a third table as shown by Table 3. The sheet size and the mode have been already described in connection with the first embodiment and therefore, are not any longer described.

TABLE 3

| Sheet Size | Mode | Directivity |
|---|---|---|
| (1) A4 Vertical | ON | YES |
| (2) A4 Lateral | OFF | NO |
| (3) B5 Vertical | ON | NO |
| (4) A3 Lateral | OFF | NO |

The directivity indicates the necessity of printing on a sheet in a predetermined direction. More specifically, for example, when a sheet of a printing medium is punched, scored, lined or framed, that is, when an image shall be printed in a predetermined portion of a punched, scored, lined or framed sheet, and when different margins are set in the upper, lower, right and left sides of the sheet, it is necessary to print an image on the sheet in a specified direction. If such sheets are set in the automatic sheet-feed cassettes 5a and 5b such that the leading end and the trailing end of a traveling sheet will be asymmetric with each other, the unmatched state may occur. A case wherein it is necessary to print an image in a specified direction as described above is referred to as a case of directivity, and a case where it is not necessary to print an image in any specified direction is referred to as a case of non-directivity. In the third table, the directivity/non-directivity for each sheet size is also recorded.

By operating the touch panel 32, a user inputs information on the mode (the curl inhibition mode or the ordinary mode) and information on the directivity/non-directivity for each sheet size (that is, for each of the automatic sheet-feed cassettes 5a and 5b). At this time, the touch panel 32 serves as a mode information receiver for receiving information on whether it is necessary to inhibit sheet curl and also as a directivity information receiver for receiving information on whether sheets contained in the automatic sheet-feed cassettes 5a and 5b have directivity. In accordance with the inputted information, the control section 30 updates the third table stored in the storage section 31.

When the control section 30 receives a print job from a user, the control section 30 commands the feed rollers 7a, 7b, 7c, 7d and 7e and the reversing section 22 to perform sheet feeding. More specifically, in the curl inhibition mode, the control section 30 commands the automatic sheet-feed cassette 5a or 5b containing sheets of a size designated by the print job to feed out a sheet, and commands the reversing section 22 to turn over the sheet. Thereafter, the feed rollers 7a, 7b, 7c, 7d and 7e feed the turned-over sheet. Further, in a case of non-directivity, the control section 30 commands the image forming apparatus 1 to print an image on the sheet in the first direction. On the other hand, in a case of directivity, the control section 30 commands the image forming apparatus 1 to print an image on the sheet in the second direction and prohibits the image forming apparatus 1 from performing finishing, such as stapling and punching, to the sheet.

In the ordinary mode, the reversing section 22 does not operate, and the sheet is fed by the feed rollers 7a, 7b, 7c, 7d and 7e. The control section 30 commands the image forming apparatus 1 to print an image on the sheet in the first direction.

### Operation of the Image Forming Apparatus

Next, referring to the drawings, the operation of the image forming apparatus 1 of the above-described structure is described. The image forming apparatus 1 performs a mode setting operation, a printing operation and a mode canceling operation. The mode canceling operation performed by this image forming apparatus 1 is the same as that performed by the image forming apparatus 1 according to the first embodiment, and a description thereof is omitted.

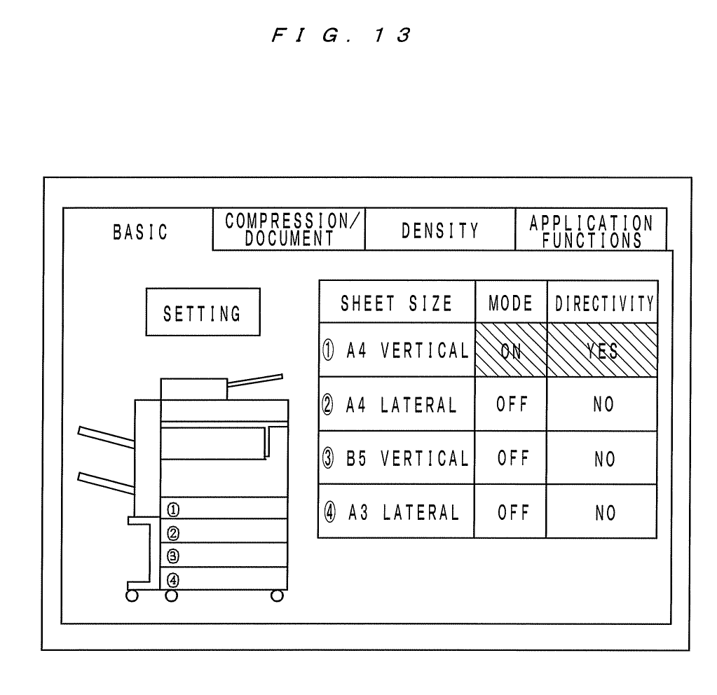

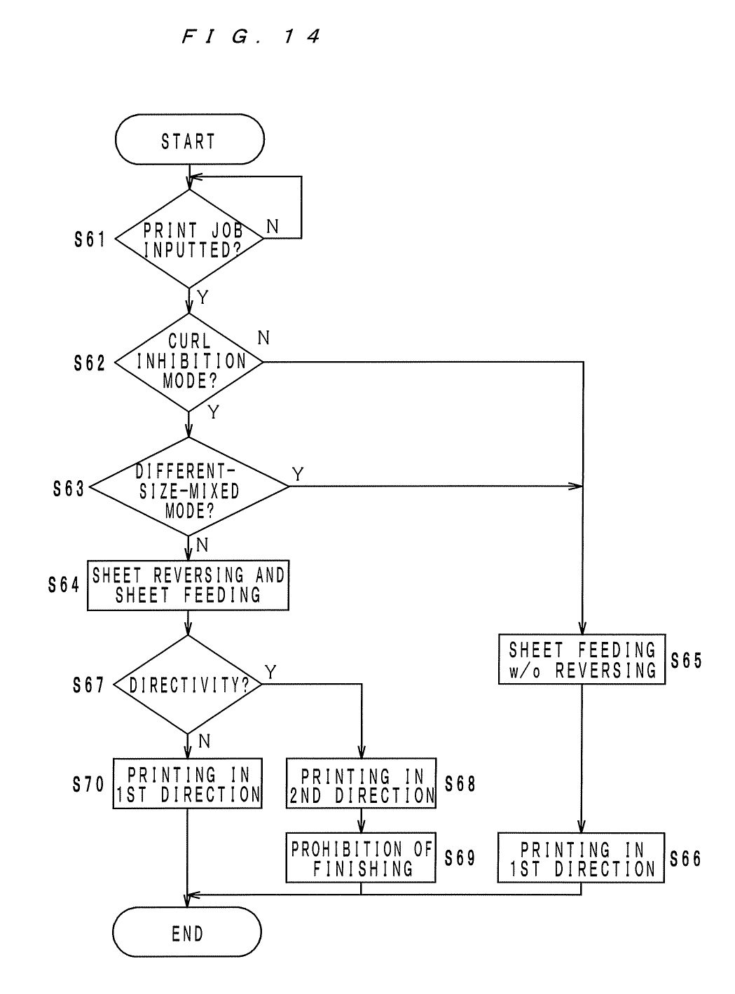

First, referring to FIGS. 12 and 13, the mode setting operation is described.

A user operates the touch panel 32, and in response, the control section 30 displays a mode setting screen on the touch panel 32 (step S51). As is shown by FIG. 13, in the mode setting screen, the mode and the directivity are displayed relative to each sheet size.

The control section 30 stands by while detecting whether a sheet size has been selected for a setting of the curl inhibition mode (step S52). In the meantime, the user selects a sheet size for setting of the curl inhibition mode on the touch panel 32. In FIG. 13, the sheet size “A4 vertical” is selected.

Next, the control section 30 stands by while detecting whether the mode has been changed from the ordinary mode (OFF) to the curl inhibition mode (ON) (step S53). In the meantime, the user changes the mode for the selected sheet size from “OFF” to “ON”. In FIG. 13, the mode for the sheet size “A4 vertical” is changed from “OFF” to “ON”.

Next, the control section 30 stands by while detecting whether the user has changed the directivity (step S54). In the meantime, the user changes the directivity for the selected sheet size from “YES” to “NO” or from “NO” to “YES” on the touch panel 32. In FIG. 13, the directivity for the selected sheet size “A4 vertical” is changed from “NO” to “YES”.

Then, the control section 30 updates the third table as shown by Table 3 stored in the storage section 31 (step S55). In the case shown by FIG. 13, the mode for the sheet size “A4 vertical” is changed from “OFF” to “ON”, and the directivity for the sheet size “A4 vertical” is changed from “NO” to “YES”. Then, the mode setting operation is completed.

Next, referring to FIG. 14, the printing operation is described.

The control section 30 stands by while detecting whether a print job has been inputted (step S61). By operating the touch panel 32, a user selects a sheet size and makes a print start command. If the print job is a different-size-mixed job which commands the image forming apparatus 1 to print images on sheets of different sizes, the user makes an input at the touch panel 32 to indicate that the print job is a different-size-mixed job. Thereby, the control section 30 receives a print job.

When the control section 30 receives a print job, the control section recognizes the sheet size designated by the print job and detects whether the curl inhibition mode is set for the sheet size with reference to the third table as shown by Table 3 (step S62). When the curl inhibition mode is set, the processing goes to step S63. When the curl inhibition mode is not set, the processing goes to step S65.

When the curl inhibition mode is set, the control section 30 judges whether the print job is a different-size-mixed job (step S63). When the print job is not a different-size-mixed job, the processing goes to step S64. When the print job is a different-size-mixed job, the processing goes to step S65.

At step S65, the control section 30 commands the pairs of feed rollers 7a and 7b to feed a sheet without operating the reversing section 22 (step S65). More specifically, the control section 30 commands the automatic sheet-feed cassette 5a or 5b containing sheets of the size designated by the print job to feed out a sheet. Next, the control section 30 controls the switch pawls 24a or 24b to be positioned to guide the sheet to the feed route R. Thereby, the sheet is fed into the sheet feed route R.

Next, the control section 30 controls the image forming apparatus 1 such that an image is printed on the sheet in the first direction (step S66). More specifically, the control section 30 commands the feed rollers 7c, 7d and 7e to feed the sheet. In the meantime, a toner image directed in the first direction is transferred onto the sheet at the second transfer section 13, and the transferred toner image is fixed on the sheet by the fixing device 15. Thereafter, the printed sheet is ejected onto the ejection section 9 through the pair of ejection rollers 17. Then, the printing operation is completed.

When it is judged at step S63 that the print job is not a different-size-mixed job, the control section 30 commands the reversing section 22 and the pairs of feed rollers 7a and 7b to turn over and feed a sheet (step S64). More specifically, the control section 30 commands the automatic sheet-feed cassette 5a or 5b containing sheets of the size designated by the print job to feed out a sheet. Next, the control section 30 controls the switch pawl 24a or 24b to be positioned to guide the sheet to the route R2 or R4, and the control section 30 commands the pair of reversing rollers 23a or 24c to convey the sheet down to the reversing route R5. Thereafter, the control section 30 reverses the rotation of the reversing rollers 23a, 23b and 23c, whereby the sheet is conveyed upward in the reversing route R5. Thus, the sheet is turned over and fed to the sheet feed route R. Thereafter, the processing goes to step S67.

Next, the control section 30 recognizes the sheet size designated by the print job and judges whether sheets of the size have directivity (step S67). When the sheets have directivity, the processing goes to step S68. When the sheets do not have directivity, the processing goes to step S67.

When the sheets have directivity, the control section 30 controls the image forming apparatus 1 such that an image will be printed on the sheet in the second direction (step S68). More specifically, the control section commands the feed rollers 7c, 7d and 7e to feed the sheet. In the meantime, a toner image directed in the second direction is transferred onto the sheet at the second transfer section 13, and the transferred toner image is fixed on the sheet by the fixing device 15. Then, the printed sheet is ejected onto the ejection section 9 through the pair of ejection rollers 17. Further, the control section 30 prohibits the image forming apparatus 1 from performing finishing, such as punching and stapling (step S69). Then, the printing operation is completed.

When the sheets do not have directivity, the control section 30 controls the image forming apparatus 1 such that an image will be printed on the sheet in the first direction (step S70). More specifically, the control section commands the feed rollers 7c, 7d and 7e to feed the sheet. In the meantime, a toner image directed in the first direction is transferred onto the sheet at the second transfer section 13, and the transferred toner image is fixed on the sheet by the fixing device 15. Then, the printed sheet is ejected onto the ejection section 9 through the pair of ejection rollers 17. The processes at steps S64 to S70 are repeated until the print job is completed. Then, the printing operation is completed.

### Advantages

As described above, in the image forming apparatus 1 according to the third embodiment, when printing is to be performed in the curl inhibition mode onto a sheet having directivity, an image rotated at 180 degrees to the original direction (first direction) is printed. Thereby, when an image is printed in the curl inhibition mode on a punched sheet or the like, the printed sheet is prevented from turning into an unmatched state wherein the printing direction and the position of holes are not matched with each other.

In the third embodiment described above, the image forming apparatus 1 of the structure according to the first embodiment is controlled such that an image rotated at 180 degrees to the original direction will be printed when printing is performed in the curl inhibition mode onto a sheet having directivity. However, it is possible to control the image forming apparatus 1 of the structure according to the second embodiment in the same way.

In the description of the image forming apparatuses 1 according to the first to third embodiments, the upper surface of a sheet of a printing medium means the surface which faces up when the sheet is set in the automatic sheet-feed cassette 5a or 5b, and the lower surface of a sheet of a printing medium means the surface which faces down when the sheet is set in the automatic sheet-feed cassette 5a or 5b.

### Summary

An image forming apparatus comprises: a cassette for containing sheets of a printing medium; a reverser for turning over a sheet of the printing medium; a feeder for feeding a sheet of the printing medium; a printer for printing an image on the sheet fed by the feeder; a curl inhibition information receiver for receiving curl inhibition information on whether to inhibit the sheet from curling; and a controller for controlling the reverser and the feeder, when the curl inhibition information received by the curl inhibition information receiver indicates necessity of inhibiting sheet curl, the controller controlling the reverser and the feeder to turn over and feed a sheet, and when the curl inhibition information received by the curl inhibition information receiver indicates unnecessity of inhibiting sheet curl, the controller controlling the reverser and the feeder to feed a sheet without turning over the sheet.

According to one embodiment, the curl inhibition information receiver receives curl inhibition information on whether to inhibit sheet curl, and based on the information, it is determined whether the sheet needs to be turned over. Thus, the image forming apparatus inhibits sheet curl without requiring a user to do tiresome work, such as turning-over and reset of the sheets in the cassette.

In the image forming apparatus, a user may input the curl inhibition information by use of the curl inhibition information receiver, and the image forming apparatus may further comprise a storage for storing the curl inhibition information inputted by the user.

The image forming apparatus may have a plural number of cassettes, which are to contain sheets of different sizes. In this case, the user inputs the curl inhibition information for each of the cassettes by use of the curl inhibition information receiver, and the storage stores the curl inhibition information for each of the cassettes.

The image forming apparatus may be designed such that the controller controls the cassette, the reverser, the feeder and the printer to carry out a print job and on completion of the print job, changes the curl inhibition information from a state which indicates necessity of inhibiting sheet curl to a state which indicates unnecessity of inhibiting sheet curl. With this arrangement, in a next print job, turning-over of sheets contrary to the user's intension is prevented.

The image forming apparatus may be designed such that when the cassette becomes empty of sheets, the controller may change the curl inhibition information from a state which indicates necessity of inhibiting sheet curl to a state which indicates unnecessity of inhibiting sheet curl. When the cassette becomes empty of sheets, a user sets sheets of a printing medium in the cassette. At this time, sheets of a different kind from the sheets previously contained in the cassette may be set, and/or the way of setting sheets at this time may be different from the previous sheet setting. Accordingly, by changing the curl inhibition information from a state which indicates necessity of inhibiting sheet curl to a state which indicates unnecessity of inhibiting sheet curl at this time, turning-over of sheets contrary to the user's intension is prevented.

The image forming apparatus comprising a plural number of cassettes may be designed such that when one of the cassette is opened, the controller changes the curl inhibition information for the opened cassette from a state which indicates necessity of inhibiting sheet curl to a state which indicates unnecessity of inhibiting sheet curl. The fact that any one of the cassettes is opened generally means that a user is setting sheets in the cassette. Therefore, sheets of a different kind may be set in the opened cassette in a different way. Accordingly, by changing the curl inhibition information for the opened cassette from a state which indicates necessity of inhibiting sheet curl to a state which indicates unnecessity of inhibiting sheet curl at this time, turning-over of sheets contrary to the user's intension is prevented.

Further, the image forming apparatus may further comprise an input part at which a user inputs information on when the curl inhibition information is to be changed from a state which indicates necessity of inhibiting sheet curl to a state which indicates unnecessity of inhibiting sheet curl.

The image forming apparatus may be designed such that when a print job requests printing on sheets of different sizes, even if the curl inhibition information indicates necessity of inhibiting sheet curl, the controller controls the reverser and the feeder to feed a sheet without turning over the sheet.

In the image forming apparatus, the curl inhibition information receiver may be a detector for detecting curl of the sheet fed by the feeder. In this case, the detector automatically receives the curl inhibition information on whether to inhibit sheet curl (on occurrence of sheet curl), and it is not necessary for a user to consider the possibility of occurrence of sheet curl.

The image forming apparatus may further comprise a directivity information receiver for receiving directivity information on whether the sheets of the printing medium contained in the cassette have directivity. In this case, the apparatus may be designed such that when the curl inhibition information indicates unnecessity of inhibiting sheet curl, the printer prints an image on the sheet in a first direction, and when the curl inhibition information indicates necessity of inhibiting sheet curl, if the directivity information indicates that the sheets do not have directivity, the controller controls the printer to print an image on the sheet in the first direction, and if the directivity information indicates that the sheets have directivity, the controller controls the printer to print an image on the sheet in a second direction rotated at 180 degrees to the first direction.

The image forming apparatus may further comprise a finisher for stapling and/or punching sheets printed by the printer, and in this case, the apparatus may be designed such that when the curl inhibition information indicates necessity of inhibiting sheet curl, if the directivity information indicates that the sheets have directivity, the controller prohibits the finisher from performing stapling and punching.

What is claimed is:

1. An image forming apparatus comprising:
a cassette for containing sheets of a printing medium;
a reverser for turning over a sheet of the printing medium;
a feeder for feeding a sheet of the printing medium;
a printer for printing an image on the sheet fed by the feeder;
a curl inhibition information receiver for receiving curl inhibition information on whether to inhibit the sheet from curling; and
a controller for controlling the reverser and the feeder, when the curl inhibition information received by the curl inhibition information receiver indicates necessity of inhibiting sheet curl, the controller controlling the reverser and the feeder to turn over and feed a sheet, and when the curl inhibition information received by the curl inhibition information receiver indicates unnecessity of inhibiting sheet curl, the controller controlling the reverser and the feeder to feed a sheet without turning over the sheet.

2. An image forming apparatus according to claim 1,
wherein a user inputs the curl inhibition information by use of the curl inhibition information receiver; and
further comprising a storage for storing the curl inhibition information inputted by the user.

3. An image forming apparatus according to claim 2,
wherein a plural number of cassettes, which are to contain sheets of different sizes, are provided;
wherein the user inputs the curl inhibition information for each of the cassettes by use of the curl inhibition information receiver; and
wherein the storage stores the curl inhibition information for each of the cassettes.

4. An image forming apparatus according to claim 2,
wherein the controller controls the cassette, the reverser, the feeder and the printer to carry out a print job and on completion of the print job, changes the curl inhibition information from a state which indicates necessity of inhibiting sheet curl to a state which indicates unnecessity of inhibiting sheet curl.

5. An image forming apparatus according to claim 2,
wherein when the cassette becomes empty of sheets, the controller changes the curl inhibition information from a state which indicates necessity of inhibiting sheet curl to a state which indicates unnecessity of inhibiting sheet curl.

6. An image forming apparatus according to claim 3,
wherein when one of the cassettes is opened, the controller changes the curl inhibition information for the opened cassette from a state which indicates necessity of inhibiting sheet curl to a state which indicates unnecessity of inhibiting sheet curl.

7. An image forming apparatus according to claim 4, further comprising an input part at which a user inputs information on when the curl inhibition information is to be changed from a state which indicates necessity of inhibiting sheet curl to a state which indicates unnecessity of inhibiting sheet curl..

8. An image forming apparatus according to claim 3,
wherein when a print job requests printing on sheets of different sizes, even if the curl inhibition information indicates necessity of inhibiting sheet curl, the controller controls the reverser and the feeder to feed a sheet without turning over the sheet.

9. An image forming apparatus according to claim 1,
wherein the curl inhibition information receiver is a detector for detecting curl of the sheet fed by the feeder.

10. An image forming apparatus according to claim 1,
further comprising a directivity information receiver for receiving directivity information on whether the sheets of the printing medium contained in the cassette have directivity;
wherein when the curl inhibition information indicates unnecessity of inhibiting sheet curl, the printer prints an image on the sheet in a first direction;
wherein when the curl inhibition information indicates necessity of inhibiting sheet curl, if the directivity information indicates that the sheets do not have directivity, the controller controls the printer to print an image on the sheet in the first direction, and if the directivity information indicates that the sheets have directivity, the controller controls the printer to print an image on the sheet in a second direction rotated at 180 degrees to the first direction.

11. An image forming apparatus according to claim 10,
further comprising a finisher for stapling and/or punching sheets printed by the printer;
wherein when the curl inhibition information indicates necessity of inhibiting sheet curl and if the directivity information indicates that the sheets have directivity, the controller prohibits the finisher from performing stapling and punching.
